(19) United States
(12) Patent Application Publication
(10) Pub. No.: US 2016/0354284 A1
(43) Pub. Date: Dec. 8, 2016

(54) MEDICATION DISPENSING SYSTEM AND METHOD AND NON-STATIONARY COMPUTER READABLE RECORDING MEDIUM

(71) Applicants: Yu-Cing Liou, New Taipei City (TW); Ci-Jyun Liang, New Taipei City (TW); Cheng-Hsuan Yang, New Taipei City (TW); Ming-Chang Wen, New Taipei City (TW); Chung-Nan Tsai, New Taipei City (TW); Yi-Chun Lu, New Taipei City (TW); Ya-Cherng Chu, New Taipei City (TW); Chih-Hung Huang, New Taipei City (TW)

(72) Inventors: Yu-Cing Liou, New Taipei City (TW); Ci-Jyun Liang, New Taipei City (TW); Cheng-Hsuan Yang, New Taipei City (TW); Ming-Chang Wen, New Taipei City (TW); Chung-Nan Tsai, New Taipei City (TW); Yi-Chun Lu, New Taipei City (TW); Ya-Cherng Chu, New Taipei City (TW); Chih-Hung Huang, New Taipei City (TW)

(73) Assignee: Optoma Corporation, New Taipei City (TW)

(21) Appl. No.: 14/973,755

(22) Filed: Dec. 18, 2015

Related U.S. Application Data
(60) Provisional application No. 62/169,554, filed on Jun. 2, 2015.

(51) Int. Cl. A61J 7/04; A61J 1/03; A61J 7/00

(52) U.S. Cl. CPC A61J 7/04; A61J 7/0084; A61J 1/035; A61J 2200/30

(57) ABSTRACT

A medication dispensing system, method and non-stationary computer readable recording medium thereof are provided. The medication dispensing system includes a medication dispenser adapted to accommodate a plurality of medicine units for dispensation. The medication dispenser includes a user interface unit, an identifier, and a processor. The identifier is adapted to communicate with an identifiable unit. The processor is coupled to the user interface unit and the identifier. The processor is configured for obtaining an identification data recorded in the identifiable unit through the identifier and identifying a user identity related to the medicine units based on the identification data, receiving a first command through the user interface unit, wherein the first command includes a daily routine schedule, scheduling a medication schedule according to the daily routine schedule after the user identity is identified, and executing a medicine outputting operation and a reminding operation according to the medication schedule.

### CROSS-REFERENCE TO RELATED APPLICATION

This application claims the priority benefits of U.S. provisional application Ser. No. 62/169,554, filed on Jun. 2, 2015. The entirety of the above-mentioned patent application is hereby incorporated by reference herein and made a part of this specification.

### BACKGROUND OF THE INVENTION

### 1. Field of the Invention

The invention generally relates to a medicine dispensing technology, in particular, to a medication dispensing system, medication dispensing method, and non-stationary computer readable recording medium capable of automatically scheduling a medication dispensing schedule.

### 2. Description of Related Art

A patient suffering from chronic diseases, such as high blood pressure, heart diseases or diabetes, needs to follow prescription orders to take medicine for a long period of time, so as to control the patient's conditions (e.g. blood pressure). It raises treatment effectiveness when medicine is being taken based on a schedule and improves the quality of life.

In current technology, a phone call is utilized to remind the patient to take medicine. Alternatively, a reminding signal or a reminding message is outputted by mobile devices, such as a mobile phone and a wearable electronic device (e.g. a smart watch), to remind the patient to take medicine. The aforementioned method merely notifies the patient at fixed time. In general, the fixed time is set by medication service providers or vendors, and thus the fixed time is unchangeable. However, the patient is annoyed by the notification when the fixed time set by medication service providers and daily routine of the patient are different and incompatible. Furthermore, the current technology is unable to meet everyone's need, since daily routine of each patient is different.

Therefore, how to effectively prevent the patient from forgetting to take medicine or mistaking medication is an important issue that needs to be solved.

The information disclosed in this “background of the invention” section is only for enhancement of understanding of the background of the described technology and therefore it may contain information that does not form the prior art that is already known to a person of ordinary skill in the art. Further, the information disclosed in the “background of the invention” section does not mean that one or more problems to be resolved by one or more embodiments of the invention is acknowledged by a person of ordinary skill in the art.

### SUMMARY OF THE INVENTION

Accordingly, the invention is directed to a medication dispensing system, a medication dispensing method, and a non-stationary computer readable recording medium thereof, which is capable of adaptively dispensing medicine according to a daily routine schedule inputted by the patent.

Other objects and advantages of the invention can be further understood via the technical features disclosed in the invention.

To achieve one, a portion, or all of the above objects or other objects, an embodiment of the invention provides a medication dispensing system. The medication dispensing system includes a medication dispenser adapted to accommodate a plurality of medicine units for dispensation. The medication dispenser includes a user interface unit, an identifier, and a processor. The identifier is adapted to communicate with an identifiable unit. The processor is electronically coupled to the user interface unit and the identifier. The processor is configured for obtaining an identification data recorded in the identifiable unit through the identifier and identifying a user identity related to the medicine units based on the identification data, receiving a first command through the user interface unit, wherein the first command comprises a daily routine schedule, scheduling a medication schedule according to the daily routine schedule after the user identity is identified, and executing a medicine outputting operation and a reminding operation according to the medication schedule.

In an embodiment of the medication dispensing system of the invention, the step of scheduling the medication schedule according to the daily routine schedule includes setting a dispensing period according to the daily routine schedule and allocating at least one dispensing time within the dispensing period to update the medication schedule according to the daily routine schedule. A number of the at least one dispensing time is determined based on the daily routine schedule.

In an embodiment of the medication dispensing system of the invention, the step of executing the medicine outputting operation and the reminding operation according to the medication schedule includes determining whether the at least one dispensing time is reached, generating a first control signal and a second control signal when the at least one dispensing time is reached, executing the medicine outputting operation according to the first control signal, and executing the reminding operation according to the second control signal.

In an embodiment of the medication dispensing system of the invention, the processor is further configured for obtaining medication information through the identifier after the user identity is identified. The step of scheduling the medication schedule according to the daily routine schedule includes setting a dispensing period according to the daily routine schedule, obtaining a consuming frequency of the medication information, and allocating at least one dispensing time within the dispensing period to update the medication schedule according to the daily routine schedule and the consuming frequency. A number of the at least one dispensing time is determined based on the consuming frequency.

In an embodiment of the medication dispensing system of the invention, the step of executing the medicine outputting operation and the reminding operation according to the medication schedule includes determining whether the at least one dispensing time is reached, generating a first control signal and a second control signal when the at least one dispensing time is reached, executing the medicine outputting operation according to the first control signal, and executing the reminding operation according to the second control signal.

In an embodiment of the medication dispensing system of the invention, the medication dispenser further includes an output unit and a first reminding unit. The output unit and the first reminding unit are coupled to the processor. The step of executing the medicine outputting operation and the reminding operation according to the medication schedule includes controlling the output unit to output at least one of the medicine units according to the medication schedule and activating the first reminding unit to output a reminding signal according to the medication schedule.

In an embodiment of the medication dispensing system of the invention, the reminding signal includes at least one of a sound alarm, a vibration alarm, and a visual alarm.

In an embodiment of the medication dispensing system of the invention, the identifier is a radio frequency identification reader or a near field communication reader to receive the identification data recorded in the identifiable unit.

In an embodiment of the medication dispensing system of the invention, the medicine units are arranged as a pill pack roll, and the identifiable unit is connected to the pill pack roll or is one of the medicine units of the pill pack roll.

In an embodiment of the medication dispensing system of the invention, the medication dispensing system further includes a mobile reminder adapted to be connected to or separated from the medication dispenser. The processor is further configured for receiving a second command and synchronizing a reminding time of the mobile reminder with the medication schedule in response to the second command and controlling the mobile reminder to output a reminding signal according to the reminding time.

In an embodiment of the medication dispensing system of the invention, the processor is further configured for executing the medicine outputting operation according to the second command. A number of the medicine units out of the medication dispenser is determined according to the second command.

In an embodiment of the medication dispensing system of the invention, the medication dispenser further includes a memory coupled to the processor and configured for storing an authorization data. The step of identifying the user identity related to the medicine units based on the identification data includes determining whether the identification data is identical to the authorization data and confirming the user identity is identified when the identification data is identical to the authorization data.

In an embodiment of the medication dispensing system of the invention, the processor is further configured for disabling the medicine outputting operation when the user identity is not identified.

In an embodiment of the medication dispensing system of the invention, the user interface unit includes at least one of a physical knob, a virtual knob, a physical button, a virtual button, and a touch panel.

An embodiment of the invention provides a medication dispensing method adapted for a medication dispensing system comprising a medication dispenser. In the medication dispensing method, an identifiable unit is communicated with to obtain an identification data recorded in the identifiable unit through an identifier of the medication dispenser. Then, a user identity related to the medicine units is identified based on the identification data. Furthermore, a first command is received through a user interface unit of the medication dispenser, wherein the first command includes a daily routine schedule. Moreover, a medication schedule is scheduled according to the daily routine schedule after the user identity is identified. In addition, a medicine outputting operation and a reminding operation are executed according to the medication schedule.

In an embodiment of the medication dispensing method of the invention, the step of scheduling the medication schedule according to the daily routine schedule includes setting a dispensing period according to the daily routine schedule and allocating at least one dispensing time within the dispensing period to update the medication schedule according to the daily routine schedule. A number of the at least one dispensing time is determined based on the daily routine schedule.

In an embodiment of the medication dispensing method of the invention, the step of executing the medicine outputting operation and the reminding operation according to the medication schedule includes determining whether the at least one dispensing time is reached, generating a first control signal and a second control signal when the at least one dispensing time is reached, executing the medicine outputting operation according to the first control signal, and executing the reminding operation according to the second control signal.

In an embodiment of the medication dispensing method of the invention, the medication dispensing method further includes obtaining medication information through the identifier after the user identity is identified. The step of scheduling the medication schedule according to the daily routine schedule includes setting a dispensing period according to the daily routine schedule, obtaining a consuming frequency of the medication information, and allocating at least one dispensing time within the dispensing period to update the medication schedule according to the daily routine schedule and the consuming frequency. A number of the at least one dispensing time is determined based on the consuming frequency.

In an embodiment of the medication dispensing method of the invention, the step of executing the medicine outputting operation and the reminding operation according to the medication schedule includes determining whether the at least one dispensing time is reached, generating a first control signal and a second control signal when the at least one dispensing time is reached, executing the medicine outputting operation according to the first control signal, and executing the reminding operation according to the second control signal.

In an embodiment of the medication dispensing method of the invention, the step of executing the medicine outputting operation and the reminding operation according to the medication schedule includes controlling an output unit of the medication dispenser to output at least one of the medicine units according to the medication schedule and activating a first reminding unit of the medication dispenser to output a reminding signal according to the medication schedule.

In an embodiment of the medication dispensing method of the invention, the identifier is a radio frequency identification reader or a near field communication reader, and the identifier receives the identification data recorded in the identifiable unit.

In an embodiment of the medication dispensing method of the invention, the medicine units are arranged as a pill pack roll, and the identifiable unit is connected to the pill pack roll or is one of the medicine units of the pill pack roll.

In an embodiment of the medication dispensing method of the invention, the medication dispensing system further includes a mobile reminder adapted to be connected to or separated from the medication dispenser. The medication dispensing method further includes receiving a second command and synchronizing a reminding time of the mobile reminder with the medication schedule in response to the second command and controlling the mobile reminder to output a reminding signal according to the reminding time.

In an embodiment of the medication dispensing method of the invention, the medication dispensing method further includes executing the medicine outputting operation according to the second command. A number of the medicine units out of the medication dispenser is determined according to the second command.

In an embodiment of the medication dispensing method of the invention, the medication dispenser further includes a memory configured for storing an authorization data. The step of identifying the user identity related to the medicine units based on the identification data includes determining whether the identification data is identical to the authorization data and confirming the user identity is identified when the identification data is identical to the authorization data.

In an embodiment of the medication dispensing method of the invention, the medication dispensing method further includes disabling the medicine outputting operation when the user identity is not identified.

An embodiment of the invention provides non-stationary computer readable recording medium. The non-stationary computer readable recording medium is adapted to electronically couple to a processor of a medication dispenser. The non-stationary computer readable recording medium is configured for storing a plurality of program codes. When the program codes are loaded into the processor, the processor adapts to execute the program codes to accomplish following steps: communicating with an identifiable unit to obtain an identification data recorded in the identifiable unit through an identifier, identifying a user identity related to the medicine units based on the identification data, receiving a first command through a user interface unit, wherein the first command includes a daily routine schedule, scheduling a medication schedule according to the daily routine schedule after the user identity is identified, and executing a medicine outputting operation and a reminding operation according to the medication schedule.

Based on the above, the embodiments of the invention include at least one of the following advantages or efficacy. In the embodiment of the invention, the user identity related to the medicine units may be identified to avoid mistaken medication. Furthermore, in the embodiment of the invention, the medicine outputting operation and the reminding operation may be executed according to the patient's daily routine, so as to dispense the medicine units and remind the patient to take medication effectively. Accordingly, a customized medication schedule can be achieved, and the patient's needs may be satisfied effectively.

Other objectives, features and advantages of the present invention will be further understood from the further technological features disclosed by the embodiments of the present invention wherein there are shown and described preferred embodiments of this invention, simply by way of illustration of modes best suited to carry out the invention.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a medication dispensing system according to an embodiment of the invention.

FIG. 1A is a block diagram illustrating a medication dispensing system according to another embodiment of the invention.

FIG. 1B is a block diagram illustrating a medication dispensing system according to another embodiment of the invention.

FIG. 2A and FIG. 2B are schematic diagrams respectively illustrating a medication dispensing system according to an embodiment of the invention.

FIG. 3 is a flow chart illustrating a medication dispensing method according to an embodiment of the invention.

FIG. 4 is a flow chart illustrating another medication dispensing method according to an embodiment of the invention.

FIG. 5A is a flow chart illustrating one specific embodiment of the medication dispensing method.

FIG. 5B is a flow chart illustrating one specific embodiment of the medication dispensing method.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

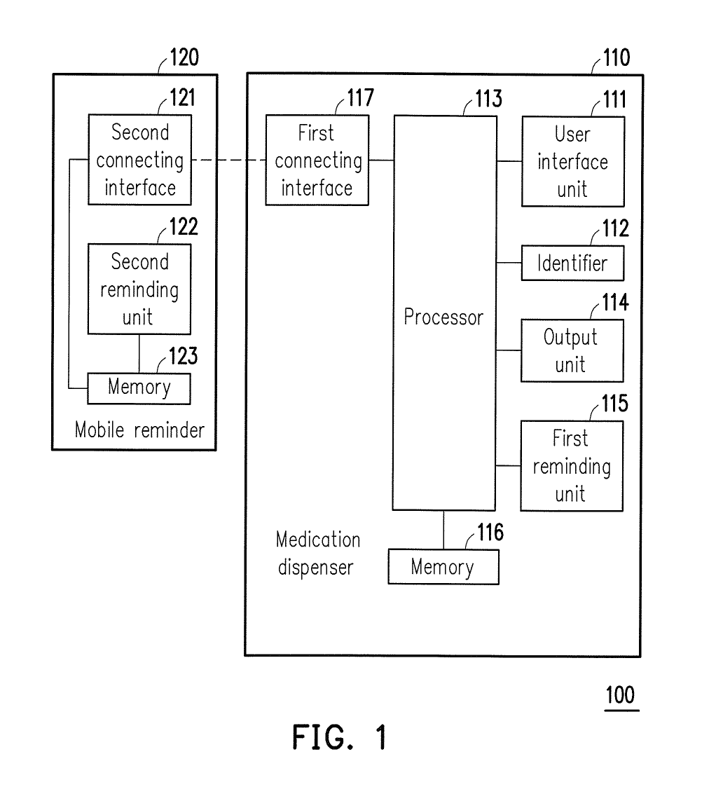

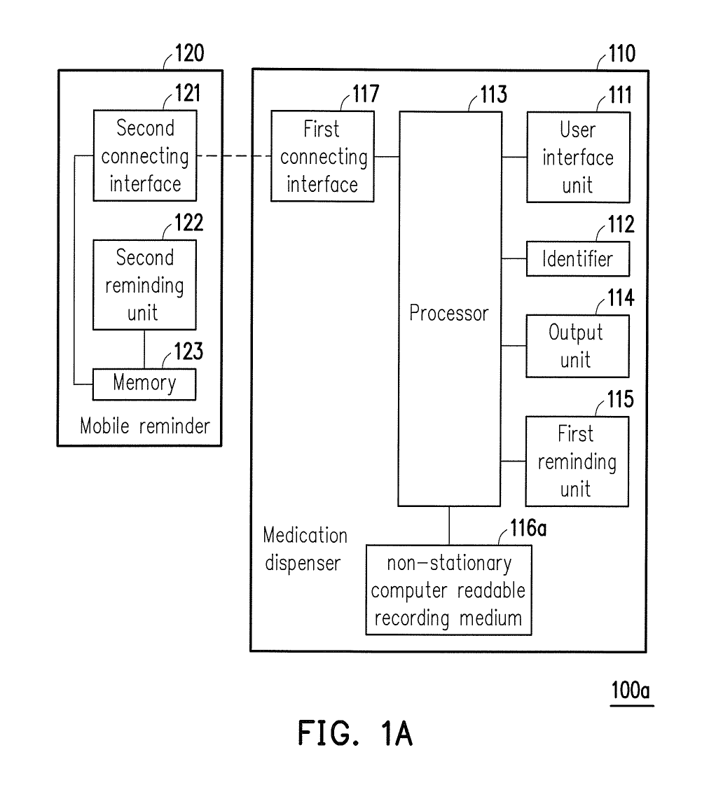

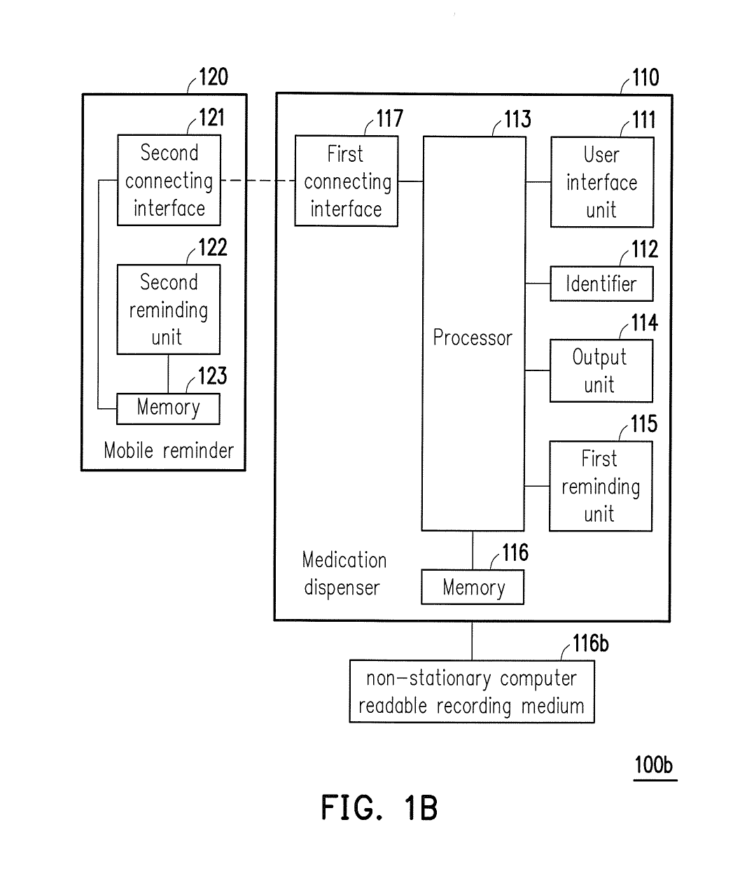

Referring to FIG. 1, FIG. 1 is a block diagram illustrating a medication dispensing system according to an embodiment of the invention. In the embodiment, a medication dispensing system 100 includes a medication dispenser 110 and a mobile reminder 120. In the embodiment, the medication dispenser 110 may be adapted to accommodate medicine units (such as pills, etc.), and may be used for reminding the patient to take medication (e.g. to take medicine) while the patient is at home. On the other hand, the mobile reminder 120 may be adapted to be connected to or separated from the medication dispenser 110. In the embodiment, when the patient goes outdoors with the mobile reminder 120 on the go, the mobile reminder 120 may remind the patient to take medication while the patient is outdoor.

Specifically, in the embodiment of the invention, the medication dispenser 110 may include a user interface unit 111, an identifier 112, a processor 113, an output unit 114, a first reminding unit 115, a memory 116, and a first connecting interface 117. The processor 113 is electronically coupled to the user interface unit 111 and the identifier 112. The processor 113 is also electronically coupled to the output unit 114, a first reminding unit 115, a memory 116, and a first connecting interface 117. In additional, in the embodiment, the processor 113 has several physical ports to electronically connect with the user interface unit 111, identifier 112, output unit 114, first reminding unit 115, and memory 116.

The user interface unit 111 is, for example, at least one of a physical knob, a virtual knob, a physical button, a virtual knob, a virtual button displayed on a screen, and a touch panel. To be more specific, in an embodiment of the invention, the physical/virtual knob/button may be a turning knob or a push button, and the virtual knob/button may be fanned by 2D imaging or 3D imaging, not limited.

The identifier 112 is, for example, a radio frequency identification (RFID) reader (e.g. an active RFID reader or a passive RFID reader) or a near field communication (NFC) reader (e.g. an active NFC reader or a passive NFC reader). However, the identifier 112 may be other suitable reader for reading/identifying medicine units, and the invention is not limited thereto.

The processor 113 may be one or a combination of a central processing unit (CPU), a programmable general-purpose microprocessor, specific-purpose microprocessor, a digital signal processor (DSP), analog signal processor, a programmable controller, application specific integrated circuits (ASIC), a programmable logic device (PLD), an image processor, graphics processing unit (GPU), or any other similar device. In the other embodiment, the processing unit may be processing software, such as signal processing software, digital signal processing software (DSP software), analog signal processing software, image processing software, graphics processing software, audio processing software. The processor 113 may be used for processing all tasks of the medication dispenser and would execute functions related to the proposed method of the disclosure of the invention.

In the embodiment, the output unit 114 may used for delivering at least one of the medicine units and outputting at least one of the medicine units. For example, in a case that the medicine units are arranged as a pill pack roll, the output unit 114 may scroll the medicine units, such that the medicine units may be conveyed out from an opening of the medication dispenser 110 (described in the following content).

In the embodiment, the first reminding unit 115 would include at least but not limited to a speaker, a vibrating oscillator, one or more light emitting diodes (LED), or/and a display. However, the first reminding unit 115 with timer may be any type of or other suitable reminder for reminding, notification, alarm or warning, and the invention is not limited thereto.

In an embodiment, the memory 116 may record data accessed and executed by the processor 113. In the embodiment, the memory 116 is, for example, one or a combination of a stationary or mobile random access memory (RAM), read-only memory (ROM), flash memory, hard disk, or any other similar device. In other embodiment, the memory 116 may be virtual memory or other similar storage unit implemented by software or program.

In the embodiment, the first connecting interface 117 may be a wireless interface (e.g. Bluetooth or WiFi) or a cable interface (e.g. a universal serial bus (USB)), which may be used for connecting to a second connecting interface 121 of the mobile reminder 120. However, the first connecting interface 117 of the medication dispenser 110 may be any type of or other suitable interface for connecting with the mobile reminder 120, and the invention is not limited thereto.

On the other hand, in the embodiment, the mobile reminder 120 may include a second connecting interface 121, a second reminding unit 122, and a memory 123.

In the embodiment, the second connecting interface 121 may be a wireless interface (e.g. Bluetooth or WiFi) or a cable interface (e.g. a universal serial bus (USB)), which may be used for connecting to the first connecting interface 117 of the medication dispenser 110 and may support the same communication protocol utilized by the first connecting interface 117 of the medication dispenser 110. However, the second connecting interface 121 of the mobile reminder 120 may be any type of or other suitable interface for connecting with the medication dispenser 110, and the invention is not limited thereto. Besides, the medication dispenser 110 may be connected to the mobile reminder 120 via wired or wireless manner. Thus, a connection between the medication dispenser 110 and the mobile reminder 120 may be established for transmitting information and communicating.

In the embodiment, the second reminding unit 122 would include at least but not limited to a speaker, a vibrating oscillator, one or more light emitting diodes (LED), or/and a display. However, the second reminding unit 122 may be any type of or other suitable reminder for reminding, notification, alarm or warning, and the invention is not limited thereto.

In the embodiment, the memory 123 is, for example, one or a combination of a stationary or mobile random access memory (RAM), read-only memory (ROM), flash memory, hard disk, or any other similar device. In other embodiment, the memory 123 may be virtual memory or other similar storage unit implemented by software or program. In the embodiment, the memory 123 may be coupled to the second connecting interface 121 and the second reminding unit 122, such that data received through the second connecting interface 121 may be recorded in the memory 123.

In an embodiment, the mobile reminder 120 may further include a controller (not shown) or a processing unit (not shown), which may access or execute the data recorded in the memory 123, and therefore may control or execute the second reminding unit 122. Nevertheless, the controller or the processing unit of the mobile reminder 120 may be one component of the processor 113. In this case, the controller or the processing unit of the mobile reminder 120 may be controlled by the processor 113 of the medication dispenser 110 through the communication between the first connecting interface 117 and the second connecting interface 121 if the medication dispensing system 100 is operated in a master-slave configuration, for example. However, the medication dispensing system 100 may be also adapted to operate in a peer-to-peer configuration or other suitable configuration, and the invention is not limited thereto.

FIG. 1A and FIG. 1B are block diagrams illustrating medication dispensing systems according to another embodiments of the invention.

Referring to FIG. 1A, the medication dispensing system 100a of FIG. 1A includes a non-stationary computer readable recording medium 116a electronically coupled to the processor 113. The processor 113 may identify the user identity related to the medicine units (such as a pill pack) through the authorization data stored in the memory 116a or the identifier 112 of the medication dispenser 110, so as to avoid the situation of mistaking medication. The non-stationary computer readable recording medium 116a may store a plurality of program codes and the program codes are configured for loading into a processor 113 disposed within the medication dispenser 110. For example, the non-stationary computer readable recording medium 116a may include a non-volatile memory. After these program codes are loaded into a processor, the processor executes these program codes to accomplish various steps of the medication dispensing method and related operations described in foregoing exemplary embodiments. The non-stationary computer readable recording medium 116a may be a read-only memory (ROM), a flash memory, a CD-ROM, a magnetic tape, a floppy disc, or an optical data storage device.

Referring to FIG. 1B, the medication dispenser 110 of the medication dispensing system 100b of FIG. 1B physically connects with a non-stationary computer readable recording medium 116b, and the non-stationary computer readable recording medium 116b electronically couples to the processor 113. The non-stationary computer readable recording medium 116b may be a USB flash drive, a flash memory card, a read-only memory (ROM), a CD-ROM, a magnetic tape, a floppy disc, or an optical data storage device, etc.

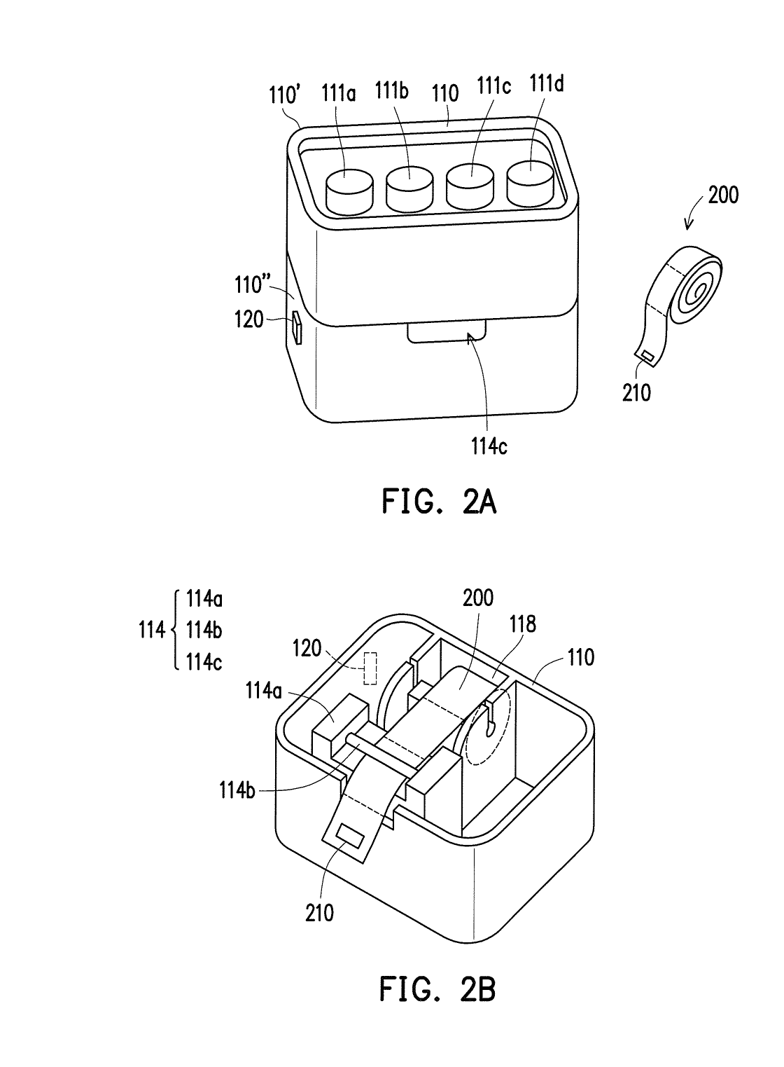

FIGS. 2A and 2B are schematic diagrams respectively illustrating a medication dispensing system according to an embodiment of the invention, which illustrates an exemplary configuration of the medication dispensing system 100. Suppose that the exemplary scenario has the medication dispensing system 100 belonging to a particular patient, and the medication dispensing system 100 is placed at the patient's home for reminding the patient to take medication.

Referring to FIGS. 2A and 2B, in an embodiment of the invention, the medication dispenser 110 may be adapted to accommodate medicine units 200, and an exemplificative case of the medicine units 200 not placed inside the medication dispenser 110 is illustrated in FIG. 2A. In brief, the medication dispenser 110 may include an upper shell 110′and a body 110″. Referring to FIG. 1 and FIGS. 2A-2B, in the embodiment, the user interface unit 111 may include four physical knobs 11 la, 111b, 111c, and 111d. The physical knobs 111a, 111b, 111c, and 111d may be set on the upper shell 110′ of the medication dispenser 110. Moreover, in the embodiment, the mobile reminder 120 may be configured to a side of the body of the medication dispenser 110. In the embodiment, the mobile reminder 120 may be attached to a side of the medication dispenser 110. Alternatively, in the other embodiment, the mobile reminder 120 may be sucked to a side of the medication dispenser 110, hang on a side of the medication dispenser 110, or disposed on any position of the medication dispenser 110 through any suitable configuration. The configuration between the mobile reminder 120 and the medication dispenser 110 may be adaptively adjusted based on design requirements, and the invention is not limited thereto.

In addition, the medication dispenser 110 may further include a dispensing tray (not shown in FIG. 1) for accommodating the medicine units 200 and loading the medicine units 200 for delivering. Referring to FIGS. 2A and 2B, the output unit 114 may include an electric motor 114a, a conveyer belt 114b, and an opening 114c. In the embodiment, the opening 114c of the output unit 114 may be used for outputting at least one of the medicine units 200, such that the patient may take the outputted medicine unit directly when the other parts of the medicine units 200 are still loaded in the medication dispenser 110. In the embodiment, the medicine units 200 may be arranged as a pill pack roll, and each of the medicine units 200 may be a pill pack. A prescription may be delivered as the pill pack roll (i.e. the medicine units 200) proactive refilled and managed by a medication packing service provider.

Furthermore, in the embodiment, in order to avoid loading wrong medicine units into the medication dispenser 110, an identifiable unit 210 may be utilized. For example, the identifiable unit 210 may be connected to the pill pack roll in the embodiment, or the identifiable unit 210 may be one of the medicine units 200 of the pill pack roll in the other embodiment, however the invention is not limited thereto. In FIG. 2A, the identifiable unit 210 may be connected to the first medicine unit of the pill pack roll. In the embodiment, the identifiable unit 210 may record at least but not limited to an identification data, and the identification data may correspond to a user identity, such as the patient's name, age, sex identification, a medical record number, etc. Optionally, the identifiable unit 210 may further record medication information, such as a consuming frequency, dosage, etc.

Referring to FIG. 2B, in an embodiment of the invention, the medicine unit 200 placed into the dispensing slot 118 of the medication dispenser 110 is illustrated. For convenient description, merely elements configured to the body of the medication dispenser 110 may be presented in the embodiment.

In the embodiment, the electronic motor 114a, the conveyer belt 114b, and the opening 114c may be used for delivering and dispensing the medicine units 200. For example, the medication dispenser 110 may use a sensor (e.g. a proximity sensor but the invention is not limited thereto) to detect whether the medicine units 200 of the pill pack roll are loaded into the dispensing slot 118. Once the first medicine unit of the medicine units 200 of the pill pack roll is loaded onto the dispensing slot 118, the medicine units 200 of the pill pack roll may be transported/delivered to and fixed upon the conveyer belt 114b. Then, according to the control of the processor 113, the electronic motor 114a may drive the conveyer belt 114b in order to deliver the medicine units 200, so as to output one or more of the medicine units 200 of the pill pack roll from the opening 114c. Thus, the outputted medicine unit 114 may be torn from the medicine units 200 by the patient, so that the patient may further take medication.

In the aforementioned exemplary embodiment, the output unit 114 may push or pull the medicine units 200 in order to deliver and dispense the medicine units 200. In other embodiments, the output unit 114 may roll the pill pack roll directly. Accordingly, the implementation of the output unit is not intended to limit the invention.

In order to avoid mistaken medication, the processor 113 may further execute an identification operation to the medicine units 200 during the loading process. The medication dispensing system 100 may be registered by the patient (user). Therefore, the medication dispensing system 100 may execute the medicine outputting operation once the user identity related to the medicine units 200 is consistent with the registered patient.

In the embodiment, the memory 116 of the medication dispenser 110 may store an authorization data corresponding to the registered patient. The processor 113 may communicate with the identifiable unit 210 to obtain the identification data recorded in the identifiable unit 210 through the identifier 112. Then, the processor 113 may determine whether the identification data recorded in the identifiable unit 210 is identical to the authorization data stored in the memory 116 or the identifier 112 of the medication dispenser 110, and may confirm the user identity is identified when the identification data is identical to the authorization data.

On the other hand, in the embodiment, when the identification data is not identical to the authorization data, the processor 113 may disable the medicine outputting operation. For example, the processor 113 may control the conveyer belt 114b to stop working. Optionally, the processor 113 may further control the first reminding unit 115 to output a reminding signal to notify the patient for failed identification. Herein, the reminding signal may include at least one of a sound alarm, a vibration alarm, and a visual alarm. However, the reminding signal may be any type of or other suitable signal/indication, and the invention is not limited thereto.

In addition, in another embodiment, the processor 113 may execute the identification operation to the medicine units 200 after the medicine units 200 are loaded into the medication dispenser 110.

It is worth mentioning that the identifier 112 and the identifiable unit 210 may be implemented by different ways. For example, in an embodiment, the identifier 112 and the identifiable unit 210 may be a wireless communication module (e.g. RF transmitting module) respectively. To be more specific, if the identifier 112 is an active RFID reader and the identifiable unit 210 is a passive RFID tag, the identifier 112 may send an inquiry signal and may receive an identification data record in the identifiable unit 210 in response to the inquiry signal.

In another embodiment, the identifiable unit 210 may be a one-dimensional code (e.g. barcode) or a two-dimensional code (e.g. QR code). Correspondingly, the identifier 112 may be an image capturing unit (e.g. a camera) for capturing the image of the identifiable unit 210. Therefore, the processor 113 may execute an image processing operation based on the captured image of the identifiable unit 210, in order to identify the user identity based on the identifiable unit 210.

Moreover, the medication dispensing system 100 may schedule a medication schedule based on a daily routine schedule of the patient, so as to satisfy the patient's needs appropriately. In detail, the patient may input the daily routine schedule (e.g. dining time and time to bed) by operating the user interface unit 111. If the user interface unit 111 includes four physical knobs 111a-111d as illustrated in FIG. 2A, the patient may adjust at least one of the physical knobs 111a-111d to input the daily routine schedule. From the perspective of the medication dispensing system 100, the processor 113 may receiving a first command through the user interface unit 111, and the first command may include the daily routine schedule in the embodiment.

In an embodiment, the setting of the daily routine schedule may be an only-one setting input by the patient while the medicine units 200 are loaded into the medication dispenser 110. In the other embodiment, the setting of the daily routine schedule may be an everyday setting input by the patient. However, the invention is not limited thereto.

After the daily routine schedule is received, the processor 113 may set a dispensing period according to the daily routine schedule, and may allocate at least one dispensing time within the dispensing period to update the medication schedule according to the daily routine schedule. In the exemplificative case that the daily routine schedule includes a breakfast time, a lunch time, a dinner time, or/and the time to bed, and the dispensing period may be, for example, between the breakfast time and the time to bed. Thus, the processor 113 could allocate the at least one dispensing time between the breakfast time and the time to bed, and each of the dispensing time may correspond to the daily routine of the patient. In this case, a number of the at least one dispensing time may be determined based on the daily routine schedule, and the invention is not limited thereto.

In another exemplary embodiment, the processor 113 may be further configured for obtaining the medication information through the identifier 112 after the user identity is identified. In this case, the processor 113 may set the dispensing period according to the daily routine schedule (which may be similar to the aforementioned embodiment), and may further obtain a consuming frequency of the medication information. For example, the consuming frequency may be a number of times that the patient is prescribed to take medication, such as three times in a day. Then, the processor 113 may allocate at least one dispensing time within the dispensing period to update the medication schedule according to the daily routine schedule and the consuming frequency, and a number of the at least one dispensing time is determined based on the consuming frequency, though the invention is not limited thereto.

In an embodiment, after the medication schedule is scheduled, the processor 113 may determine whether the at least one dispensing time is reached. In an embodiment, the processor 113 may execute a time counting operation for timing, and the time counting operation may be implemented by a timer, a time counting circuit or by software depending upon design requirements, though the invention is not limited thereto. Then, in the embodiment of the invention, the processor 113 may generate a first control signal and a second control signal when the at least one dispensing time is reached. In the embodiment, the processor 113 may execute the medicine outputting operation according to the first control signal, and may execute the reminding operation according to the second control signal.

More specifically, for the medicine outputting operation of the embodiment, the processor 113 may control the output unit 114 to output at least one of the medicine units 200 according to the medication schedule. As for the reminding operation of the embodiment, the processor 113 may activate the first reminding unit 115 to output a reminding signal according to the medication schedule. In the embodiment, the reminding signal includes at least one of a sound alarm, a vibration alarm, and a visual alarm. For example, the processor 113 may output one pill pack of the medicine units 200 via the conveyer belt 114b and may activate the first reminding unit 115 to output a sound alarm, such as a beep sound, at the same time, so as to remind the patient to take medication. However, the medicine outputting operation and the reminding operation may be executed at the same time or individually, though the invention is not limited thereto.

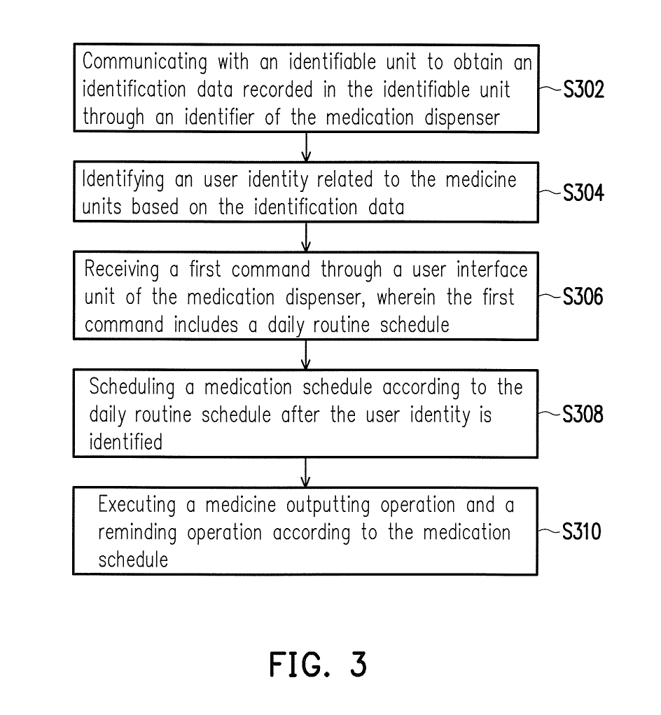

Based on the above, FIG. 3 is a flow chart illustrating a medication dispensing method according to an embodiment of the invention, which is adapted to FIGS. 2A-2B and the medication dispensing system 100/100a/100b of FIGS. 1, 1A and 1B. In step S302, the processor 113 communicates with an identifiable unit 210 to obtain an identification data recorded in the identifiable unit 210 through the identifier 112 of the medication dispenser 110. In step S304, the processor 113 identifies a user identity related to the medicine units 200 based on the identification data. In step S306, the processor 113 receives a first command through the user interface unit 111 of the medication dispenser 110, wherein the first command includes a daily routine schedule. In step S308, the processor 113 schedules a medication schedule according to the daily routine schedule after the user identity is identified. In step S310, the processor 113 executes a medicine outputting operation and a reminding operation according to the medication schedule.

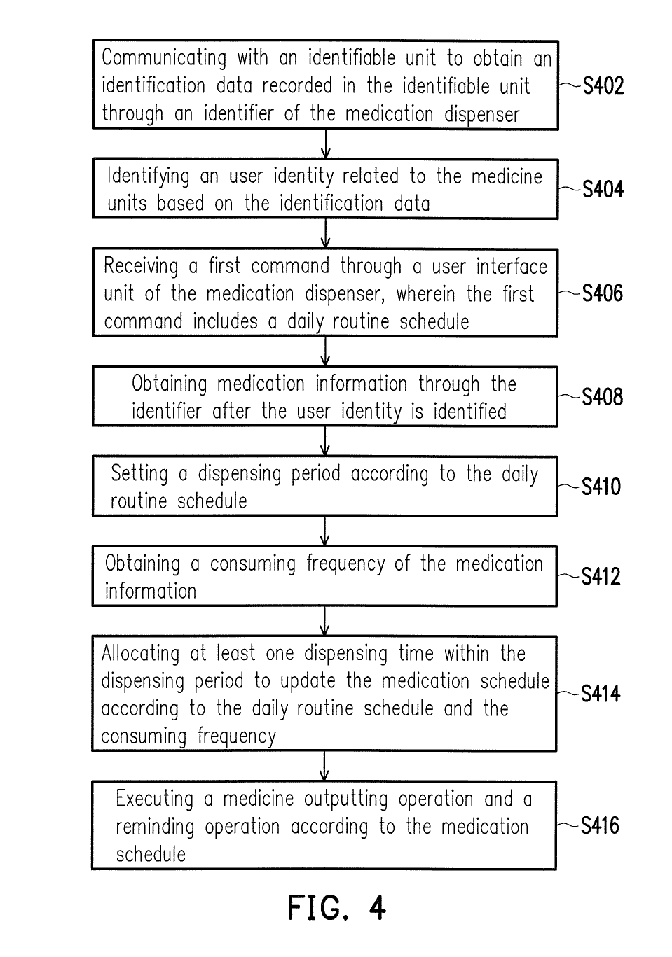

In addition, FIG. 4 is a flow chart illustrating another medication dispensing method according to an embodiment of the invention, which is adapted to FIGS. 2A-2B and the medication dispensing system 100/100a/100b of FIGS. 1, lA and 1B. In step S402, the processor 113 communicates with an identifiable unit 210 to obtain an identification data recorded in the identifiable unit 210 through the identifier 112 of the medication dispenser 110. In step S404, the processor 113 identifies a user identity related to the medicine units 200 based on the identification data. In step S406, the processor 113 receives a first command through the user interface unit 111 of the medication dispenser 110, wherein the first command includes a daily routine schedule. In step S408, the processor 113 obtains medication information through the identifier 112 after the user identity is identified. In some embodiments, the processor 113 may obtain the medication information and the identification data during the same time, though the invention is not limited thereto.

In step S410, the processor 113 sets a dispensing period according to the daily routine schedule. In step S412, the processor 113 obtains a consuming frequency of the medication information. In step S414, the processor 113 allocates at least one dispensing time within the dispensing period to update the medication schedule according to the daily routine schedule and the consuming frequency. In step S416, the processor 113 executes a medicine outputting operation and a reminding operation according to the medication schedule.

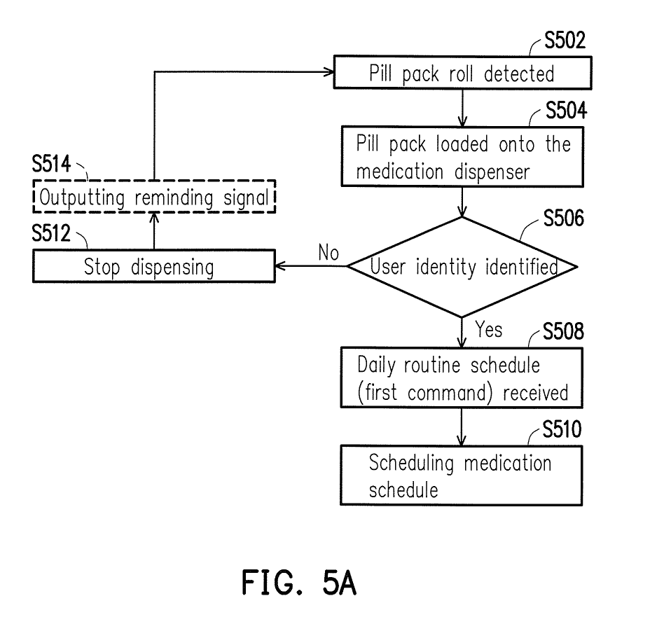

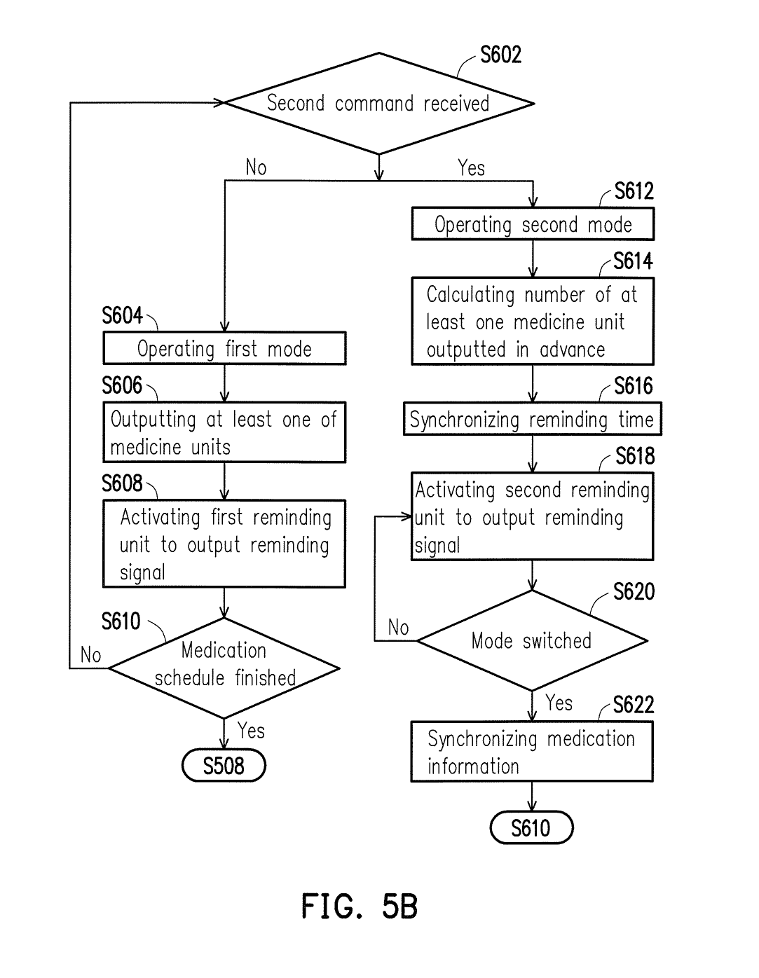

FIG. 5A and FIG. 5B elucidate the methods of FIG. 3 with various specific embodiments. FIG. 5A is a flow chart illustrating one specific embodiment of the medication dispensing method, which is adapted to FIGS. 2A-2B and the medication dispensing system 100/100a/100b of FIGS. 1, 1A and 1B. In step S502, the medicine units 200 of the pill pack roll may be detected by the processor 113 through a sensor for example. In an embodiment, the processor 113 may take sensor reading(s) from one or more sensors for the purpose of determining whether the medicine units 200 of the pill pack roll are placed into/loaded onto the dispensing slot 118 of the medication dispenser 110. In an embodiment, when the first medicine unit, for example, of the medicine units 200 of the pill pack roll is loaded onto/placed into the dispensing slot 118 of the medication dispenser 110 (step S504), the medicine units 200 of the pill pack roll may be transported to and fixed upon the conveyer belt 114b.

Afterwards, in step S506, the processor 113 may identify the user identity related to the medicine units 200 based on the identification data; wherein the identification data may be recorded in the identifiable unit 210, and may be obtained through the identifier 112. When the user identity is identified, in step S08, the daily routine schedule or the first command may be received through the user interface unit 111. Then, in step S510, the processor 113 may schedule the medication schedule according to the daily routine schedule after the user identity is identified. The steps S508 and S510 in FIG. 5A are similar to the steps S306 and S308 in FIG. 3 respectively, so details are omitted here.

On the other hand, when the user identity is not identified in step S506, the processor 113 may stop dispensing in step S512. Then, in optional step S514, the processor 113 of the embodiment may control the first reminding unit 115 to output the reminding signal, so as to notify the patient to put correct medicine units 200 (e.g. pill pack roll) corresponding to a correct identification data.

Therefore, according to the steps in FIG. 5A, the medication dispensing system 100 may automatically load the medicine units 200 after the patient placed the medicine units 200 onto the dispensing slot 118 in the embodiment. As the user identity is identified, the patient is allowed to input his/her daily routine schedule, such that the medication dispensing system 100 may automatically schedule/allocate the medication schedule based on the input daily routine schedule.

In the aforementioned cases, the patient is at home and the medication dispensing system 100 is also placed at home. In such cases, the processor 113 may control the output unit 114 of the medication dispenser 110 (e.g. through the opening 114c) to output at least one of the medicine units 200 when the dispensing time is reached. That is, the medication dispensing system 100 may provide the medicine units 200 for the patient and remind the patient directly through the medication dispenser 110, which may be regarded as operating in a first mode (e.g. an “at-home” mode).

On the other hand, the patient plans go outdoors. In such case, the patient could press a “pill on-the-go” button in order to trigger the medication dispensing system 100 to output at least one medicine unit 200 in advance. The outputted medicine unit(s) according to the above press operation (i.e. the “pill on-the-go” button is pressed) may be going to be taken out by the patient, and the patient may bring the on-the-go medicine unit(s) (i.e. the outputted medicine unit(s), described in following content) and the mobile reminder 120 for taking medicine on time. Moreover, a reminding time of the mobile reminder 120 may be synchronized with the medication schedule of the medication dispenser 110 in response to the above press operation (i.e. the “pill on-the-go” button is pressed). As such, the medication dispensing system 100 may still remind the patient to take medication through the mobile reminder 120 even if the patient carrying the mobile reminder 120 and the on-the-go medicine unit(s) goes outdoors.

It is noted that the aforementioned press operation to the “pill on-the-go” button operated by the patient may be regarded as a second command. That is, once the patient presses the “pill on-the-go” button, the processor 113 may determine that the second command is received, so as to control the medication dispensing system 100 to operate in a second mode (i.e. an “on-the-go” mode), which is adapted to remind the patient to take medication in the scenario that the patient goes outdoors.

In an embodiment, the processor 113 may execute the medicine outputting operation according to the second command (after the operation of pressing the “pill on-the-go” button), wherein a number of the medicine units 200 out of the medication dispenser 110 is determined according to the second command. More specifically, in an exemplary embodiment, each button press may serve one pill pack, though the invention is not limited thereto. In other words, the patient may estimate how many the on-the-go medicine unit(s) he/she need to take on the go, and press the “pill on-the-go” button with corresponding times. The number of the on-the-go medicine unit(s) (i.e. the number of the button press) may be counted by the processor 113, and both the medication schedule and the number of the on-the-go medicine unit(s) may be synchronized between the medication dispenser 110 and the mobile reminder 120, so as to ensure the dispensing process executed by the medication dispensing system 100 to be correct and in order.

In another embodiment, the patient may merely input the time to go out and the time back home, and the processor 113 may determine how many the on-the-go medicine unit(s) to be outputted based on a period within the time to go out and the time back home. In such case, the “pill on-the-go” button may be implemented by, for example, a virtual button displayed on a touch display panel for easier operation. Similarly, the number of the on-the-go medicine unit(s) may be counted by the processor 113, and both the medication schedule and the number of the on-the-go medicine unit(s) may be synchronized between the medication dispenser 110 and the mobile reminder 120, so as to ensure the dispensing process executed by the medication dispensing system 100 to be correct and in order.

From the above, it may be seen that the “pill on-the-go” button may be also implemented by other types, such as a physical knob/button or a virtual knob/button displayed on/above a display panel, and the invention is not limited thereto.

Moreover, the “pill on-the-go” button may be configured on the mobile reminder 120, or may be configured on the medication dispenser 110. The “pill on-the-go” button is configured on the mobile reminder 120, the mobile reminder 120 may transmit the second command through the second connecting interface 121 to the first connecting interface 117 of the medication dispenser 110, and the processor 113 may receive the second command through the first connecting interface 117. Besides, as for the another case that the “pill on-the-go” button is configured on the medication dispenser 110, the “pill on-the-go” button may be included in the user interface unit 111, and therefore the processor 113 may receive the second command through the user interface unit 111. However, the operation implement through the “pill on-the-go” button may be any suitable implement, and the invention is not limited thereto.

As such, when the medication dispensing system 100 operates in the second mode (i.e. an “on-the-go” mode), the second reminding unit 122 of the mobile reminder 120 may be activated to output a reminding signal according to the synchronized medication schedule, so as to remind the patient to take medication through the mobile reminder 120 while the patient is outdoor.

In an embodiment that the processor 113 is a single processor configured in the medication dispenser 110, the second reminding unit 122 of the mobile reminder 120 may be controlled by the processor 113 configured in the medication dispenser 110. In another embodiment that the processor 113 includes at least but not limit to a first processor (e.g. a master processor) configured in the medication dispenser 110 and a second processor (e.g. a slave processor) configured in the mobile reminder 120, and the second reminding unit 122 of the mobile reminder 120 may be controlled by the second processor of the processor 113, though the invention is not limited thereto.

In the case when the patient gets home, the mobile reminder 120 may be returned to the side of the medication dispenser 110, for example, for charging purpose. Thus, the processor 113 may detect whether the mobile reminder 120 is returned. When the mobile reminder 120 is returned, the processor 113 may switch the medication dispensing system 100 to operate in the first mode (e.g. an “at-home” mode). At this time, medication information (e.g. a rest number of the medicine unit 200), the reminding time, or/and the medication schedule may be synchronized between the medication dispenser 110 and the mobile reminder 120.

FIG. 5B is a flow chart illustrating one specific embodiment of the medication dispensing method, which is adapted to the medication dispensing system 100 of FIG. 1. The embodiment of FIG. 5B may be executed after the step S510 in the embodiment of FIG. 5A, or may be executed during step S310 in the embodiment of FIG. 3.

Referring to FIG. 5B, in step S602, the processor 113 may determine whether the second command is received. If not, in step S604, the processor 113 may control the medication dispensing system 100 to operate in the first mode (i.e. the “at-home” mode). Then, when the at least one dispensing time is reached, the processor 113 may control the output unit 114 to output at least one of the medicine unit 200 in step S606, and may activate the first reminding unit 115 to output the reminding signal in step S608. As mentioned above, the order of the step S606 and step S608 are, for example, executed in order. However, in the other embodiments, the order of the step S606 and step S608 may be executed exchanged, or may be executed at the same time. In step S610, the processor 113 may determine whether the medication schedule is finished/done. In the embodiment, when the medication schedule is finished/done, step S508 would proceed, which may indicate a scenario that the patient input an updating daily routine schedule for a new day in the embodiment. Otherwise, when the medication schedule is not finished/done, the steps S602, S604, S606 and S608 and S610 may be repeated.

On the other hand, when the second command is received, in step S612, the processor 113 may control the medication dispensing system 100 to operate in the second mode (i.e. an “on-the-go” mode). Then, in step S614, the processor 113 may calculate the number of at least one medicine unit 200 outputted an advance (i.e. the number of the on-the-go medicine unit(s)). In step S616, the processor 113 may synchronize the reminding time of the mobile reminder 120 with the medication dispenser 110 in response to the second command. In step S618, the processor 113 may activate the second reminding unit 122 of the mobile reminder 120 to output the reminding signal according to the medication schedule.

Then, in step 620, the processor 113 may determine whether to switch the operating mode. When the operating mode is switched to the first mode (e.g. the processor 113 may consider the scenario that the patient gets home), in step S622, the processor 113 may synchronize the medication information to further synchronize the reminding time and the medication schedule between the medication dispenser 110 and the mobile reminder 120. Then, the step S610 is proceeded.

On the other hand, when the processor 113 determines the operating mode is not switched (i.e. still second mode/“on-the-go” mode), the step S618 is proceeded.

However, during the flow of the steps S604, S606 and S608, the processor 113 may still confirm whether the second command is received (i.e. the step S602).

In addition, the processor 113 may further control the medication dispensing system 100 to operate in other modes. For example, when the patient may be outdoor for several days, for example, to take a trip, the patient may input a third command (e.g. a number of days of the trip) to trigger the medication dispensing system 100 to operate in a third mode. When the third mode is operated, the mobile reminder 120 may output the reminding signal according to a same medication schedule during the trip in response to the third command. That is, in this case, the patient is not required to input the daily routine schedule every day.

On the other hand, various steps of the language learning method described in foregoing exemplary embodiments can be implemented in a software or firmware form. For example, another exemplary embodiment of the invention provides a non-stationary computer readable recording medium based on the concept described in each of foregoing exemplary embodiments. The non-stationary computer readable recording medium can be any data storage device for storing data, and which stores a plurality of program codes. For example, the non-stationary computer readable recording medium may include a non-volatile memory. After these program codes are loaded into a processor, the processor executes these program codes to accomplish various steps of the medication dispensing method and related operations described in foregoing exemplary embodiments. The non-stationary computer readable recording medium may be a read-only memory (ROM), a flash memory, a CD-ROM, a magnetic tape, a floppy disc, or an optical data storage device. The computer readable recording medium may also be distributed on a computer network system so that aforementioned program codes are stored and executed in a distributed manner. Moreover, aforementioned processor may be an embedded processor or a CPU. However, the invention is not limited thereto.

To conclude the above, the embodiments of the invention provide a medication dispensing system, a medication dispensing method, and a non-stationary computer readable recording medium thereof, which may identify the user identity related to the medicine units, so as to avoid the situation of mistaking medication. Moreover, in the embodiments of the invention, the medicine outputting operation and the reminding operation may be executed according to the patient's daily routine, such that the situation of forgetting to take medication may be avoided effectively. Besides, the embodiments of the invention may further provide different operating modes to reminding the patient to take medication. Thereby, customized medication schedule can be achieved, and the patient's needs may be satisfied effectively.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. Moreover, these claims may refer to use “first”, “second”, etc. following with noun or element. Such terms should be understood as a nomenclature and should not be construed as giving the limitation on the number of the elements modified by such nomenclature unless specific number has been given.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A medication dispensing system, comprising:
a medication dispenser, adapted to accommodate a plurality of medicine units for dispensation, the medication dispenser comprising:
a user interface unit;
an identifier, adapted to communicate with an identifiable unit; and
a processor, electronically coupled to the user interface unit and the identifier, and configured for:
obtaining an identification data recorded in the identifiable unit through the identifier and identifying a user identity related to the medicine units based on the identification data;
receiving a first command through the user interface unit, wherein the first command comprises a daily routine schedule;
scheduling a medication schedule according to the daily routine schedule after the user identity is identified; and
executing a medicine outputting operation and a reminding operation according to the medication schedule.

2. The medication dispensing system according to claim 1, wherein the step of scheduling the medication schedule according to the daily routine schedule comprises:
setting a dispensing period according to the daily routine schedule; and
allocating at least one dispensing time within the dispensing period to update the medication schedule according to the daily routine schedule,
wherein a number of the at least one dispensing time is determined based on the daily routine schedule.

3. The medication dispensing system according to claim 2, wherein the step of executing the medicine outputting operation and the reminding operation according to the medication schedule comprises:
determining whether the at least one dispensing time is reached;
generating a first control signal and a second control signal when the at least one dispensing time is reached;
executing the medicine outputting operation according to the first control signal; and
executing the reminding operation according to the second control signal.

4. The medication dispensing system according to claim 1, wherein the processor is further configured for obtaining medication information through the identifier after the user identity is identified, and the step of scheduling the medication schedule according to the daily routine schedule comprises:
setting a dispensing period according to the daily routine schedule;
obtaining a consuming frequency of the medication information; and
allocating at least one dispensing time within the dispensing period to update the medication schedule according to the daily routine schedule and the consuming frequency,
wherein a number of the at least one dispensing time is determined based on the consuming frequency.

5. The medication dispensing system according to claim 4, wherein the step of executing the medicine outputting operation and the reminding operation according to the medication schedule comprises:
determining whether the at least one dispensing time is reached;
generating a first control signal and a second control signal when the at least one dispensing time is reached;
executing the medicine outputting operation according to the first control signal; and
executing the reminding operation according to the second control signal.

6. The medication dispensing system according to claim 1, wherein the medication dispenser further comprising:
an output unit, coupled to the processor; and
a first reminding unit, coupled to the processor,
wherein the step of executing the medicine outputting operation and the reminding operation according to the medication schedule comprises:
controlling the output unit to output at least one of the medicine units according to the medication schedule; and
activating the first reminding unit to output a reminding signal according to the medication schedule.

7. The medication dispensing system according to claim 6, wherein the reminding signal comprises at least one of a sound alarm, a vibration alarm, and a visual alarm.

8. The medication dispensing system according to claim 1, wherein the identifier is a radio frequency identification reader or a near field communication reader to receive the identification data recorded in the identifiable unit.

9. The medication dispensing system according to claim 1, wherein the medicine units are arranged as a pill pack roll, and the identifiable unit is connected to the pill pack roll or is one of the medicine units of the pill pack roll.

10. The medication dispensing system according to claim 1, further comprising:
a mobile reminder, adapted to be connected to or separated from the medication dispenser,
wherein the processor is further configured for:
receiving a second command and synchronizing a reminding time of the mobile reminder with the medication schedule in response to the second command; and
controlling the mobile reminder to output a reminding signal according to the reminding time.

11. The medication dispensing system according to claim 10, wherein the processor is further configured for:
executing the medicine outputting operation according to the second command, wherein a number of the medicine units out of the medication dispenser is determined according to the second command.

12. The medication dispensing system according to claim 1, wherein the medication dispenser further comprising:
a memory, coupled to the processor and configured for storing an authorization data,
wherein the step of identifying the user identity related to the medicine units based on the identification data comprises:
determining whether the identification data is identical to the authorization data; and
confirming the user identity is identified when the identification data is identical to the authorization data.

13. The medication dispensing system according to claim 1, wherein the processor is further configured for:
disabling the medicine outputting operation when the user identity is not identified.

14. The medication dispensing system according to claim 1, wherein the user interface unit comprises at least one of a physical knob, a virtual knob, a physical button, a virtual button, and a touch panel.

15. A medication dispensing method, adapted for a medication dispensing system comprising a medication dispenser, the medication dispensing method comprising:
communicating with an identifiable unit to obtain an identification data recorded in the identifiable unit through an identifier of the medication dispenser;
identifying a user identity related to the medicine units based on the identification data;
receiving a first command through a user interface unit of the medication dispenser, wherein the first command comprises a daily routine schedule;
scheduling a medication schedule according to the daily routine schedule after the user identity is identified; and
executing a medicine outputting operation and a reminding operation according to the medication schedule.

16. The medication dispensing method according to claim 15, wherein the step of scheduling the medication schedule according to the daily routine schedule comprises:
setting a dispensing period according to the daily routine schedule; and
allocating at least one dispensing time within the dispensing period to update the medication schedule according to the daily routine schedule,
wherein a number of the at least one dispensing time is determined based on the daily routine schedule.

17. The medication dispensing method according to claim 16, wherein the step of executing the medicine outputting operation and the reminding operation according to the medication schedule comprises:
determining whether the at least one dispensing time is reached;
generating a first control signal and a second control signal when the at least one dispensing time is reached;
executing the medicine outputting operation according to the first control signal; and
executing the reminding operation according to the second control signal.

18. The medication dispensing method according to claim 15, further comprising:
obtaining medication information through the identifier after the user identity is identified,
wherein the step of scheduling the medication schedule according to the daily routine schedule comprises:
setting a dispensing period according to the daily routine schedule;
obtaining a consuming frequency of the medication information; and
allocating at least one dispensing time within the dispensing period to update the medication schedule according to the daily routine schedule and the consuming frequency,
wherein a number of the at least one dispensing time is determined based on the consuming frequency.

19. The medication dispensing method according to claim 18, wherein the step of executing the medicine outputting operation and the reminding operation according to the medication schedule comprises:
determining whether the at least one dispensing time is reached;
generating a first control signal and a second control signal when the at least one dispensing time is reached;
executing the medicine outputting operation according to the first control signal; and
executing the reminding operation according to the second control signal.

20. The medication dispensing method according to claim 15, wherein the step of executing the medicine outputting operation and the reminding operation according to the medication schedule comprises:
controlling an output unit of the medication dispenser to output at least one of the medicine units according to the medication schedule; and
activating a first reminding unit of the medication dispenser to output a reminding signal according to the medication schedule.

21. The medication dispensing method according to claim 20, wherein the reminding signal comprises at least one of a sound alarm, a vibration alarm, and a visual alarm.

22. The medication dispensing method according to claim 15, wherein the identifier is a radio frequency identification reader or a near field communication reader, wherein the identifier receives the identification data recorded in the identifiable unit.

23. The medication dispensing method according to claim 15, wherein the medication dispensing method further comprising:
receiving a second command and synchronizing a reminding time of a mobile reminder of the medication dispensing system with the medication schedule in response to the second command; and
controlling the mobile reminder to output a reminding signal according to the reminding time.

24. The medication dispensing method according to claim 23, further comprising:
executing the medicine outputting operation according to the second command, wherein a number of the medicine units out of the medication dispenser is determined according to the second command.

25. The medication dispensing method according to claim 15, wherein the step of identifying the user identity related to the medicine units based on the identification data comprises:
determining whether the identification data is identical to an authorization data stored in a memory; and
confirming the user identity is identified when the identification data is identical to the authorization data.

26. A non-stationary computer readable recording medium, adapted to electronically couple to a processor of a medication dispenser, wherein the non-stationary computer readable recording medium is configured for storing a plurality of program codes, wherein when the program codes are loaded into the processor, the processor adapts to execute the program codes to accomplish following steps:
communicating with an identifiable unit to obtain an identification data recorded in the identifiable unit through an identifier;
identifying a user identity related to the medicine units based on the identification data;
receiving a first command through a user interface unit, wherein the first command comprises a daily routine schedule;
scheduling a medication schedule according to the daily routine schedule after the user identity is identified; and
executing a medicine outputting operation and a reminding operation according to the medication schedule.
